(19) United States
(12) Patent Application Publication
(10) Pub. No.: US 2007/0151607 A1
(43) Pub. Date: Jul. 5, 2007

(54) Structure of check valve

(75) Inventor: Chen-Yueh Fan, Taipei (TW)

Correspondence Address: POSZ LAW GROUP, PLC, 12040 SOUTH LAKES DRIVE, SUITE 101, RESTON, VA, 20191, US

(73) Assignee: WINNER DOUBLE-H CO., LTD., Taipei (TW)

(21) Appl. No.: 11/325,567

(22) Filed: Jan. 5, 2006

(51) Int. Cl. F16K 15/04

(52) U.S. Cl. 137/539

(57) ABSTRACT

A check valve includes a first tube, a second tube received in the first tube, a rubber ball movably received between the first tube and the second tube and a spring urged against a periphery of the rubber ball. The rubber ball is able to move away from the hole to allow water to flow out of the apertures of the second tube from the hole of the first tube when the spring is compressed and plug the hole to stop water leakage from the apertures when the spring returns to its original position.

### BACKGROUND OF THE INVENTION

1. Field of the Invention

The present invention relates to a check valve, and more particularly to a check valve easily constructed yet having the ability to stop fluid flowing from one direction to the other direction.

2. Description of the Prior Art

A check valve is used in a fluid system to stop fluid flowing from one direction to the other direction. In order to accomplish this objective, most of the check valves are composed of complicated structure and complex operation process. Therefore, the manufacture cost of the check valve is high and the maintenance fee thereof is also high. A type of a conventional check valve is composed of a rubber ball movably received between an inlet and an outlet of a water sprinkler such that when the water is flowing from the water source to the outlet of the water sprinkler, the rubber is moved away from the inlet of the water sprinkler to allow the water to smoothly flow out of the water sprinkler. When the water flow is stopped by shutting off the water supply, the pressure inside the water sprinkler forces the rubber ball back to the inlet of the water sprinkler so that there will be no fluid leakage.

Using water pressure alone seems inadequate to stop water flow from the water source. Especially, when the faucet is not turned off, the water flow will continuously flow out of the water sprinkler in that the simple structure cannot stop the pressure from the water source.

To overcome the shortcomings, the present invention tends to provide an improved check valve to mitigate the aforementioned problems.

### SUMMARY OF THE INVENTION

The primary objective of the present invention is to provide an improved check valve having simple structure yet high performance in providing a sufficient force to stop water flow even though the faucet is not turned off.

In order to accomplish the foregoing objective, the check valve of the present invention includes a first tube, a second tube received in and securely connected to the firs tube, a rubber ball movably received between the first tube and the second tube and a spring a first end of which is abutted against a face of the second tube and a second end of which is urged against the rubber ball so that water pressure resulting from the water flow is able to push the rubber ball away from a hole of the first tube and then the recoil force from the spring is able to force the rubber ball back to plug the hole of the first tube.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the check valve of the present invention;

FIG. 2 is an exploded perspective view of the check valve in FIG. 1;

FIG. 3 is a cross sectional view of the check valve by taking line 3-3 in FIG. 3;

FIG. 4 is a schematic side plan view showing the application of the check valve of the present invention; and

FIG. 5 is a schematic side plan view showing the application of the check valve in a position different to that as shown in FIG. 4.

### DETAILED DESCRIPTION OF THE PREFERRED EMBODIMENT

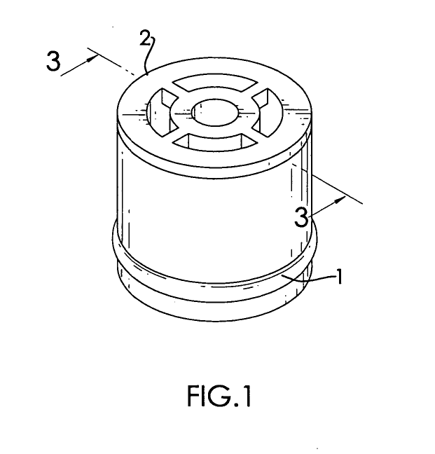

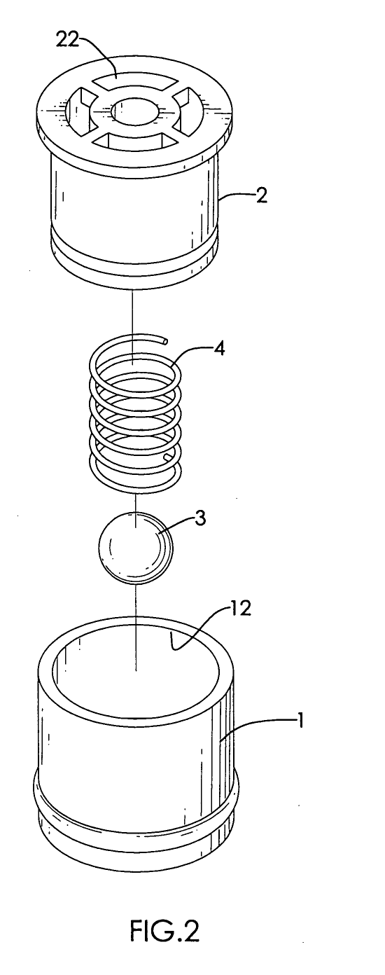

With reference to FIGS. 1 and 2, it is noted that the check valve in accordance with the present invention includes a first tube (1), a second tube (2), a rubber ball (3) and a spring (4).

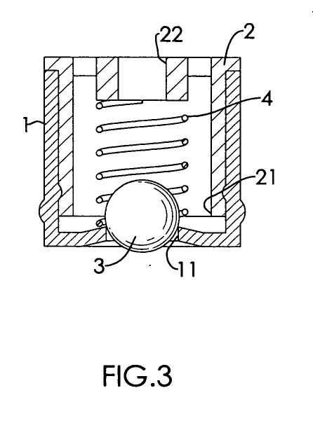

With reference to FIG. 3, the first tube (1) includes a hole (11) defined in a bottom face thereof and an opening (12) defined in a top face thereof to communicate with the hole (11). The second tube (2) is received in the first tube (1) and has a bottom opening (21) defined in a bottom face thereof and multiple apertures (22) defined in a top face thereof to communicate with the bottom opening (21).

The rubber ball (3) has a diameter slightly larger than a diameter of the hole (11) and is received in the first tube (1). One end of the spring (4) is abutted against a bottom face of the top face of the second tube (2) and the other end of the spring (4) is urged against a periphery of the rubber ball (3).

Therefore, it is noted from the depiction of FIG. 3 that the rubber ball (3) is received between the first tube (1) and the second tube (2) which is received in the first tube (1) with the bottom opening (21) in communication with the hole (11). The spring (4) is then sandwiched between the bottom face of the top face of the second tube (2) and the periphery of the rubber ball (3).

When water is flowing from the water source, the pressure of the water flow forces the rubber ball (3) away from the hole (11) of the first tube (1) to allow water to flow into the hole (11) and away from the check valve from the apertures (22) of the second tube (2). While the rubber ball (3) is moved away from the hole (11) of the first tube (1), the spring (4) is compressed so as to store a recoil force to push the rubber ball (3) back to its original position. Therefore, when the water supply is shut off, the spring (4) forces the rubber ball (3) back to plug the hole (11) such that the entire water passage is blocked and no water leakage occurs.

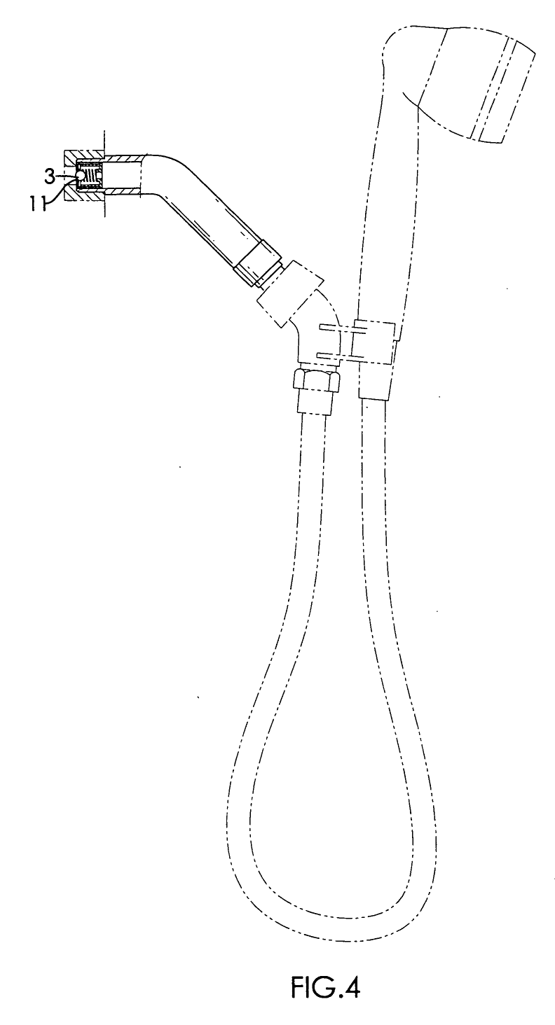

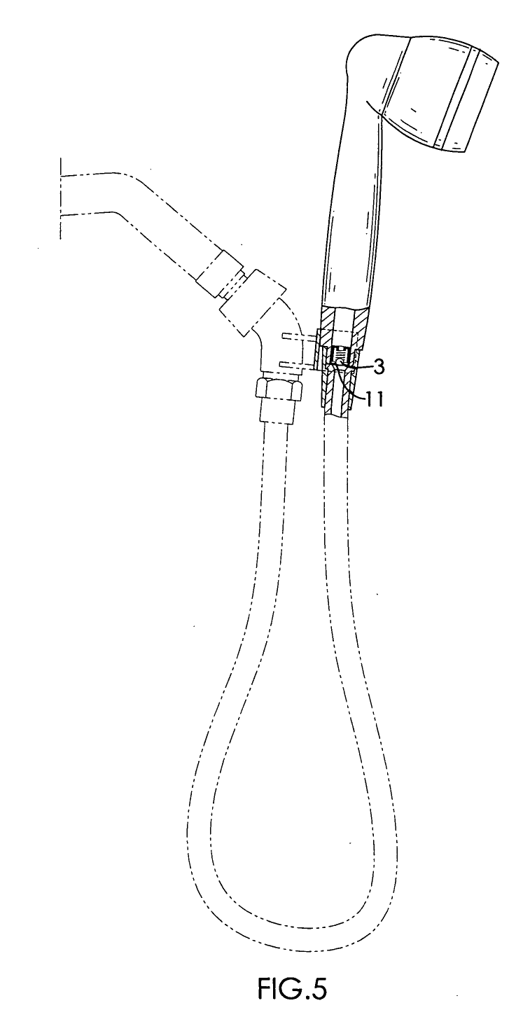

With reference to FIG. 4 and FIG. 5, it is noted that no matter where the check valve of the present invention is positioned, the rubber ball (3) always faces the direction where the water comes so that the water pressure is able to move the rubber ball (3) away from the hole (11).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A check valve comprising:
a first tube having a hole defined in a bottom face thereof and an opening defined in a top face thereof to communicate with the hole;
a second tube received in the first tube and having a bottom opening defined in a bottom face thereof to communicate with the hole of the first tube and multiple apertures defined in a top face thereof to communicate with the bottom opening and the opening of the first tube;
a rubber ball having a diameter slightly larger than a diameter of the hole and is movably received between the first tube and the second tube;
a spring having a first end abutted against a bottom face of the top face of the second tube and a second end urged against a periphery of the rubber ball,
whereby the rubber ball is able to move away from the hole to allow water to flow out of the apertures of the second tube from the hole of the first tube when the spring is compressed and plug the hole to stop water leakage from the apertures when the spring returns to its original position.
